(19) United States
(12) Patent Application Publication
(10) Pub. No.: US 2026/0151972 A1
(43) Pub. Date: Jun. 4, 2026

(54) METHOD FOR MANUFACTURING A TRANSPARENT PLASTIC LENS WITH EMBEDDED DECORATIVE ELEMENTS

(71) Applicant: BARBERINI S.P.A., Silvi (IT)

(72) Inventors: Matteo LAGASI, Torino (IT); Antonio SIMEONE, Torino (IT)

(21) Appl. No.: 19/122,607

(22) PCT Filed: Oct. 18, 2023
(86) PCT No.: PCT/IB2023/060510

§ 371 Date: Apr. 18, 2025

(30) Foreign Application Priority Data
Oct. 19, 2022 (EP) 22425050.6

(51) Int. Cl. B29D 11/00

(52) U.S. Cl. CPC B29D 11/00317; B29D 11/00355; B29D 11/00442; B29D 11/0048; B29D 11/00865

(57) ABSTRACT

The present invention relates to a method for manufacturing a molded ophthalmic article (1) comprising at least one decorative element (2), said method comprises the steps of: a—providing a mold (100) comprising a first mold element (102) and a second mold element (104) configured to cooperate together in a closed position to define a cavity (3), b—fixing said at least one decorative element (2) inside said cavity (3), c—casting a first molding liquid comprising monomers of a first transparent plastic material or injecting a transparent thermoplastic material inside said cavity (3), d—curing said first molding liquid comprising monomers of a first transparent plastic material or cooling said transparent thermoplastic material and demolding said mold (100) to obtain a molded ophthalmic article (1) comprising at least one decorative element (2).

The present invention relates to a method for manufacturing a transparent plastic lens with at least one in-mass embedded decorative element of different shapes, dimensions, materials and aesthetic effects.

The term transparent plastic lens refers to a corrective lens or to a lens without any corrective power. The lenses can be used as spectacle glass, sunglasses for eye protection, goggles, visors or a high fashion item.

Eyeglasses or sunglasses normally are meant for medical functions, in particular to protect the eye from Solar Radiation or from physical harm, to ease vision or to correct the vision of the wearer. In the current industry is becoming more and more important the level of personalization and aesthetic that is requested by the final customer. For that reason, expanding the possible technologies available in order to obtain new aesthetic effects creates value for the customer.

In the modern industry, the spectacle frames are generally made from polymers or metals using different manufacturing technologies. Many decoration techniques are known and used to decorate, engrave and enrich the frames composing the spectacle. Those technologies are scalable, reliable and widely available.

However, concerning the lenses, the possible portfolio of decorative techniques is limited. In particular, techniques that are easy to implement and offer a wide range of decoration possibilities with an industrial application are not easily available. Such decorations must then keep intact the main characteristics of a lens, corrective or not, such as transparency and optical quality without interfering with the vision of the final user or without compromising the mechanical characteristics of the lens.

Today, decoration of the lenses often consists in applying for example an interference filter on the lenses to get a mirror effect or a specific tinted color in transmission. Also branding for example is done on the surface of the lenses with several technologies, but the interested area is always limited to a small portion. Examples of decoration technologies include inkjet printing, vacuum coating mirroring, pad-printing, laser marking. In any case, these types of decorations leave the aesthetic element exposed to damage, or in general give no tridimensional depth effect and are limited in the field of application, since they are always taken from different businesses and industry fields.

Considering these notions, an innovative improvement in the field would be one to protect the decoration, allow the encapsulation of different 3D or 2D elements of different materials inside the mass of the transparent plastic lens, protecting them from external damage and thus improving the overall quality of the decorated optical lens. This would also unlock new aesthetic effects and combinations.

For 3D elements are intended decorative elements such as diamonds, pearls, crystals, gemstones, metal pieces and all other kind of decorative and/or aesthetical elements having non-planar dimensions. In particular, they may vary in dimensions, shapes, colors, materials (both organic and inorganic) or with added visual functionality like photo luminescent, phosphorescent or photochromic effects.

For 2D elements are intended decorative and/or aesthetical elements having planar dimensions.

In the state of the art, methods for the manufacturing of plastic lenses with embedded decorative elements are disclosed in EP3730997A1, US2022155494A1, EP0390443A1, JPH07137158A and EP4057052A1.

The present invention therefore aims to propose a method for manufacturing a transparent plastic lens with at least one embedded decorative element as set forth in claim 1.

Further characteristics of the method are the subject of the dependent claims.

The characteristics and advantages of the method according to the present invention will become more evident from the following description, exemplifying and not limiting, referring to the attached schematic drawings in which:

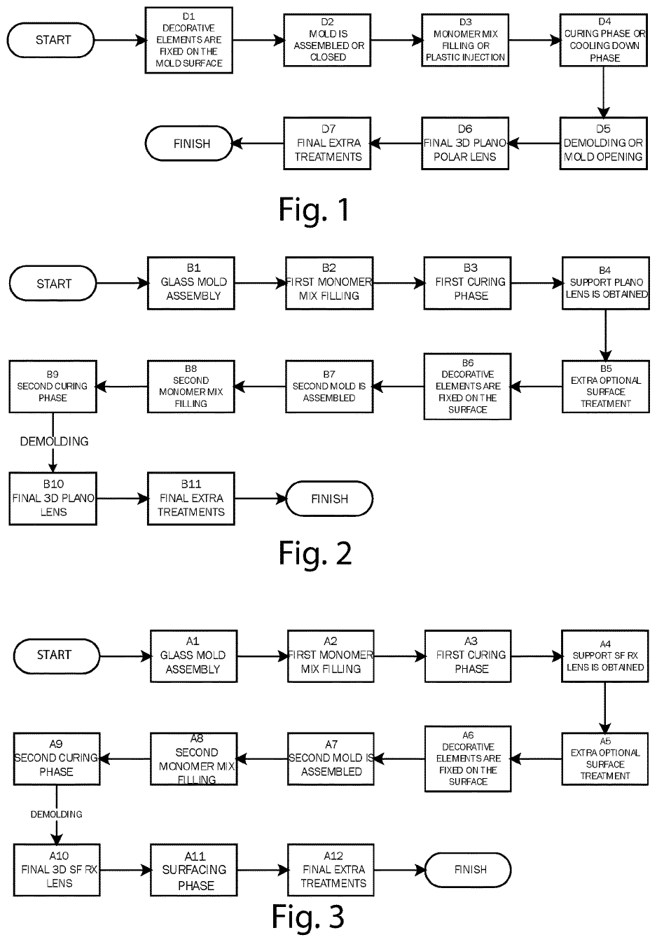

FIG. 1 is a scheme relating to a first embodiment according to the present invention,

FIG. 2 is a scheme relating to the first embodiment according to the present invention, wherein one of the mold elements itself is obtained by molding a transparent plastic material,

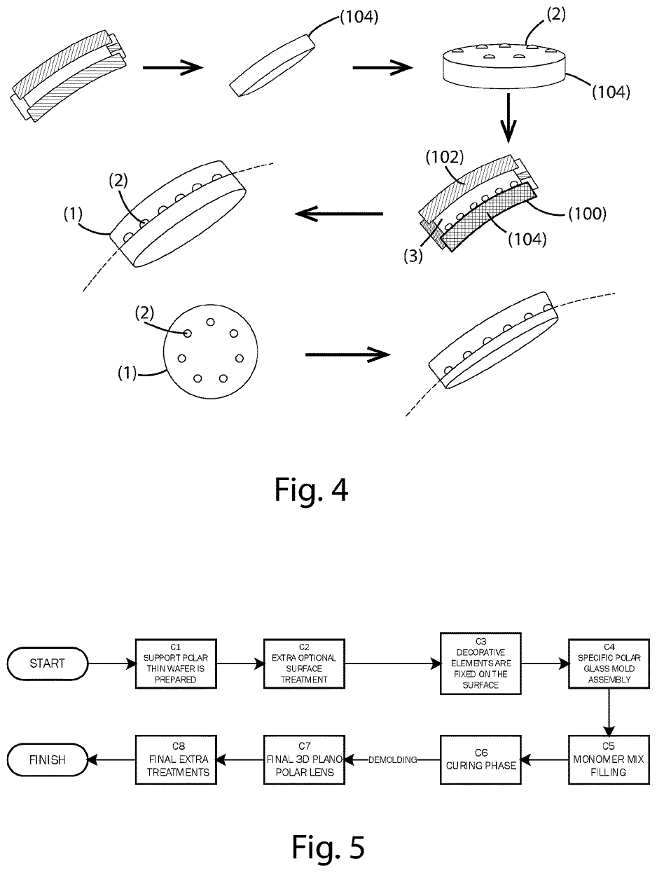

FIGS. 3 and 4 are schemes relating to the first embodiment according to the present invention wherein one of the mold elements itself is obtained by molding a transparent plastic material and the ophthalmic article is subjected to a step of surfacing;

FIG. 5 is a scheme relating to a second embodiment according to the present invention.

The main concept of the proposed innovative method comprises the following essential steps:
a—providing a mold 100 comprising a first mold element 102 and a second mold element 104 configured to cooperate together in a closed position to define a cavity 3,
b—fixing said at least one decorative element 2 inside said cavity 3,
c—casting a first molding liquid comprising monomers of a first transparent plastic material or injecting a transparent thermoplastic material inside said cavity 3,
d—curing said first molding liquid comprising monomers of a first transparent plastic material or cooling said transparent thermoplastic material and demolding said mold 100 to obtain a molded ophthalmic article 1 comprising at least one decorative element 2.

As used herein, the term “transparent” in relation to an optical element, such as a plastic lens, means that the optical element has a total light transmittance value equal to or higher than 60%, preferably equal to or higher than 70%, and a haze value equal to or less than 5%, preferably equal to or less than 4%, both the total light transmittance value and the haze value being measured in accordance with ASTM D 1003.

According to the invention, the mold elements 102, 104 can be of variable dimensions, bases and thickness (preferably, the thickness is from 0.5 mm up to 10 mm). The thickness of the cavity obtained between the mold elements 102, 104 determines the final thickness of the polymerized material, i.e. the ophthalmic article 1 or the mold element 102 or 104.

FIG. 1 summarizes the method according to the first embodiment, wherein the at least one decorative element 2 in step b is fixed on the first mold element 102 or on the second mold element 104 by any mechanical or chemical means.

The at least one decorative element can be placed on the surface of the first mold element 102 or on the second mold element 104, following a specific decorative pattern, and then is anchored or glued or fixed by any mechanical, physical or chemical mean.

This process can be automatized or can be executed manually.

Polymeric glue of different nature or any adhesive material can be used to support the placing and fixation of the at least one decorative element onto the surface of the first mold element 102 or on the second mold element 104.

The at least one decorative element can present in some cases a ready to use adhesive layer specifically designed to interact with the surface of the first mold element 102 or the second mold element 104.

Advantageously, and as can been seen from FIGS. 2, 3 and 4, the second mold element 104 can be obtained by molding a second transparent plastic material, such molding of the second transparent plastic material may comprise the steps of casting and curing a second molding liquid comprising monomers of the second transparent plastic material. Afterwards, the at least one decorative element 2 in step b can be fixed on the second mold element 104.

Alternatively, the second mold element 104 can be manufactured through an injection process of a transparent thermoplastic material inside a mold.

Specifically, for the casting process as the preferred manufacturing method, a glass mold comprised of two distinctive glass lenses (i.e. mold elements) is assembled with the support of an elastomeric band or with the support of an adhesive tape.

The second transparent plastic material may be prepared starting from the same or from a different molding liquid comprising monomers than the molding liquid used for the first transparent plastic material. In one embodiment, the same molding liquid is used to obtain the first and second transparent plastic material.

When prepared by injection molding, the second transparent plastic material may be obtained using the same or different thermoplastic material than the thermoplastic material used to prepare the first transparent plastic material. In one embodiment, the same thermoplastic material is used to obtain the first and second transparent plastic material.

The glass lenses used for the mold assembly can be spherical, toric, cylindrical, flat, curved or of any possible geometry. The mold is then filled with a reactive mixture of monomers.

Typical monomers for the manufacturing of cast optical articles and suitable as first and second molding liquids comprise CR-39 and Trivex™ manufactured by PPG Industries and MR-7, MR-8, MR-10, MR-160DG manufactured by Mitsui Chemicals.

Typical thermoplastic materials suitable to prepare the first and second transparent plastic material comprise polycarbonate and polyamide (amorphous or semicrystalline).

The mold then undergoes a thermal or photochemical process that will trigger the curing process of the monomers mixture.

Finally, after a demolding process the second mold element 104 is obtained.

In essence, in this embodiment a transparent plastic lens is used as mold element. Since this plastic lens is prepared separately, for example in a mold composed of two mold elements made of glass, it may have high mechanical and optical properties and thus can be used as an optical element (half-lens) of the final ophthalmic article, that is the mold element is a constituent part of the final ophthalmic article.

When the second mold element 104 is made of a transparent plastic material, in one embodiment the at least one decorative element (2) is anchored onto said optical element.

Considering the many possible combination of materials and shapes contemplated in this innovative decorative method, an extra step can be proposed in order to promote quality and compatibility between materials, or to create particular aesthetical effects.

The second mold element 104 with the at least one decorative element can be treated using different surface treatment technologies like varnish/primer or inks application via different methods, chemical etching of the surface, chemical functionalization, plasma etching, corona etching or in general vacuum physical-chemical surface treatments and/or depositions.

Alternatively, only the at least one decorative element can undergo the same surface treatments before being anchored on the surface of the second mold element 104.

In both cases, the surface treatment, especially plasma etching, is advantageously carried out when the decorative element is made of an inorganic material or at least its external surface is made of an inorganic material. In fact, it improves the compatibility of the decorative element towards the plastic material that forms the ophthalmic article.

When the surface treatment is carried out on the second mold element 104, it improves its compatibility towards the first transparent plastic material or first transparent thermoplastic material.

Advantageously, the curing of said second molding liquid comprising monomers of the second transparent plastic material is incomplete so as to form chemical bonding between said second mold element 104 and said at least one decorative element 2 during curing in step d.

The second mold element 104 (with the at least one decorative element anchored on its surface following a particular pattern or positioning) can be used as a structural element of a second mold, i.e. the mold in step d.

When a plastic lens is used as second mold element 104, supporting the decorative element, in combination with a first mold element 102 that is made for example of glass, the method of the present invention leads to an ophthalmic article 1 comprising two optical elements, i.e. half-lenses, coupled together, the decorative element being embedded therein. Indeed, the curing of the first molding liquid comprising monomers produces a first transparent plastic material that firmly adheres to the plastic material of the second mold element 104. During the demolding operation, the first mold element 102 is removed leaving the ophthalmic article 1 made of the two half-lenses (i.e. a front lens and a back lens) sticked together and embedding the decorative element.

In one embodiment, the molding liquids comprising monomers (i.e. the polymerizable compositions) used to prepare the first and second transparent material have the same or similar composition in order to have increase the compatibility between the two half-lenses and reduce the risk of their detaching.

In one embodiment, said second molding liquid comprising monomers (i.e. second mold element 104) is not completely cured so as to obtain a partially cured second transparent plastic material. The partially cured material comprises a residual fraction of the original reactive functional species (e.g. ethylenically unsaturated groups, isocyanate groups, amine groups), which can polymerize in the subsequent curing cycle of the first molding liquid leading to an enhanced adhesion of the two half-lens components.

Similar advantages in terms of adhesion of the two optical elements are obtained when the transparent plastic material is a transparent thermoplastic material prepared by injection molding.

The embodiment in which a plastic lens is used as second mold element has also several advantages in terms of aesthetical effects that can be obtained for the ophthalmic article. Since the ophthalmic article comprises a first half-lens (e.g. a front lens) and a second half-lens (e. g. back lens), various aesthetical appearance of the ophthalmic article may be designed by imparting the desired appearance to one or both the optical elements (i.e. half-lenses). For example, in one embodiment, one of the two half-lenses (e.g. the second mold element) may be tinted, for instance by in-mass tinting or by sublimation techniques, while the other one (e.g. the first transparent plastic material) is left clear. The so-obtained ophthalmic article is suitable as sunglass lens with an enhanced appearance of the decorative element compared to a lens made of a single in-mass tinted body according to the known art. In fact, if the tinted half-lens is the back lens (i.e. the one facing the eye of the wearer) and the clear lens is the front lens, the decorative element will result more clearly visible to an observer looking at the wearer.

FIG. 5 summarizes the method according to the second embodiment of the present invention, wherein in step b, the at least one decorative element 2 is anchored onto a support polymeric thin wafer so as to be fixed inside said cavity 3.

Advantageously, the wafer can be a transparent carrier film or a functional one with light absorbing or light reflecting characteristics, or a combination of these.

Its thickness could vary between 20 microns to 0.8 millimeters.

The polymeric materials used for such wafer can vary and are known to those skilled in the art.

The wafer is positioned inside the cavity mold being fixed directly on the surface of the first mold element 102 or on the second mold element 104, or can be kept in place at a certain distance from the cavity surfaces using an appropriate elastomeric gasket or adhesive tape.

The main advantage of the method according to the second embodiment is that only one monomer mixture filling is required inside the mold, as the monomers will fill the cavity on both sides of the wafer, thus encapsulating the whole support wafer with the at least one decorative element.

Advantageously, according to the t first or the second embodiment, the method further comprises before step b a step of surface treatment of said at least one decorative element 2, wherein said step of surface treatment are selected from one or more of varnish/primer, inks application, chemical etching of the surface, chemical functionalization, plasma etching, corona etching or vacuum physical-chemical surface treatments and/or depositions.

After fixing the at least one decorative element 2 inside the cavity 3 according to the first or second embodiment, the molding in steps c and d of the present invention takes place in the same method of molding the second transparent plastic material to obtain the second mold element 104 as described above.

The molding liquid comprising monomers of a transparent plastic material is casted inside the cavity 3, wherein the liquid can have the same, similar or different chemical composition of the second transparent plastic material.

After a similar curing and demolding process, the final molded ophthalmic article 1 is obtained, with the at least one decorative element encapsulated and protected in its mass.

Alternatively, the molding in steps c and d of the present invention may take place by heating and injecting a transparent thermoplastic material inside the cavity. The type of the transparent thermoplastic material and the operating conditions are known for the person skilled in the art.

Afterword, the transparent thermoplastic material is cooled and the mold 100 is open, the final molded ophthalmic article 1 is obtained with the at least one decorative element encapsulated and protected in its mass.

Preferably, and as can be shown in FIGS. 3 and 4, the molded ophthalmic article 1 can be subjected to a step of surfacing to reduce its thickness and optionally to obtain an optical power.

Alternatively, the molded ophthalmic article 1 is adapted to have a predefined thickness without the need of a step of surfacing.

The at least one decorative element in all methods described can vary in dimensions, shapes, colors, materials (both organic and inorganic) or with added visual functionality like photoluminescent, phosphorescent or photochromic effects.

The at least one decorative element can be bi-dimensional, including resin layers applied by pad printing or ink-jet or tri-dimensional in space, such as cabochon or other jewelry elements. Based on the color and treatments of the second mold element 104, different and new aesthetic effects can be obtained.

Preferably, the decorative element is made of an inorganic material such as diamonds, pearls, crystals, gemstones, metal pieces, glass beads or an organic material, such as plastic. The inorganic materials may be optionally coated with a coating film, such as films deposited by Physical Vapor Deposition (PVD), decorative paints, etc. The decorative element may be a 2D element or 3D element.

In particular, the thickness of the at least one decorative element shall be at most about 80% of the thickness d of the ophthalmic article lens 1 at the location where the at least one decorative element is embedded.

Preferably, the at least one decorative element may be fixed using an adhesive material, more preferably comprising a cyanoacrylate or an acrylic compound.

The at least one decorative element may be transparent or present similar or identical refractive indexes compared to the refractive indexes of the transparent plastic materials used for manufacturing the molded ophthalmic article and it has no ability to induce a local alteration of the visible light transmission of the molded ophthalmic article 1. In this case, the at least one decorative element 2 can be placed across the whole surface of the molded ophthalmic article.

On the contrary, in the case the at least one decorative element is not transparent and is visible or the at least one decorative element 2 can induce a local alteration of the visible light transmission of the molded ophthalmic article 1, its positioning on the surface of the ophthalmic article should be designed with care and attention.

A specific central area of the lens, a 30 mm circle around the optical center of the lens per ISO 12312 2022, must be free of any decoration in order to maintain intact the vision comfort of the final user.

The transparent plastic material, the second transparent plastic material and/or the support polymeric thin wafer can present extra functionalities and characteristics, for example included but not limited to are: photochromic layers, contrast enhancement filters, vacuum coated surfaces, anti-reflective coatings or combination thereof.

Advantageously, a single monomer mixture can be used instead of the reactive monomers mixture. Any thermosetting or thermoplastic material that can be normally processed without lowering the quality of the final product.

Normally, when using thermoplastic materials the injection molding process will be the preferred industrial method for filling the mold.

In that case, the lens mold can be made of glass or steel with the appropriate grade and relative surface treatments known to those skilled in the art.

Also, in the alternative case of the injection molding, the mold will be kept closed with the mechanical clamping force of the injection molding equipment.

For use in spectacles or sunglasses, the outer edge is shaped according to the desired shape of the frame of the eyeglasses or sunglasses.

Another object of the present invention is a molded ophthalmic article 1 obtained by the method according to the present invention.

By ophthalmic article 1 is meant a corrective lens or (plano-lens), finished or semi-finished, suitable for being mounted in a frame, for example a spectacle frame, goggles, a mask or a visor intended to be placed in front of the eyes and forming a screen of visual protection.

At this stage the ophthalmic article 1 which has not been submitted to further treatments, can be considered as a lens blank element.

In this context, treatments conferring additional functions, either alone or in combination among the following non-exhaustive list: shockproof, anti-scratch, anti-abrasion, anti-reflective, anti-fouling, anti-fogging, anti-static are not considered as additional layers.

These additional functions can be carried out according to conventional methods (soaking, vacuum deposition, spin coating, spray coating, etc.).

Several of these treatments may be applied before or after the creation of the final ophthalmic article.

The material of the decorative object 2 can be chosen to be compliant with the chosen molding process, which can be an injection molding process or a cast molding process.

Advantageously, it shall also be chosen not to liberate gazes in order to avoid formation of bubbles during injection or during curing in case of casting in function of the chosen molding process.

The extracted ophthalmic article 1 can be used as such, shaped to a requested form or undergo as mentioned above one or several additional treatments like deposition of a hard coat treatment, an anti-reflection treatment and/or a mirroring treatment etc.

1. A method for manufacturing a molded ophthalmic article comprising at least one decorative element, said method comprising the steps of:
a. providing a mold comprising a first mold element and a second mold element configured to cooperate together in a closed position to define a cavity
b. fixing said at least one decorative element inside said cavity;
c. casting a first molding liquid comprising monomers of a first transparent plastic material or injecting a transparent thermoplastic material inside said cavity;
d. curing said first molding liquid comprising monomers of a first transparent plastic material or cooling said transparent thermoplastic material and demolding said mold to obtain a molded ophthalmic article comprising at least one decorative element.

2. The method for manufacturing a molded ophthalmic article according to claim 1, wherein said at least one decorative element in step b is fixed on said first mold element or said second mold element by any mechanical or chemical means.

3. The method for manufacturing a molded ophthalmic article according to claim 1, wherein:
said second mold element is an optical element made of a second transparent plastic material.

4. The method for manufacturing a molded ophthalmic article according to claim 3, wherein in step b said at least one decorative element is anchored at least onto said second mold element.

5. The method for manufacturing a molded ophthalmic article according to claim 3, wherein said second mold element is an optical element obtained by:
casting and curing a second molding liquid comprising monomers of said second transparent plastic material, or
injecting and cooling a transparent thermoplastic material.

6. The method for manufacturing a molded ophthalmic article according to claim 3, wherein said second transparent plastic material is a partially cured polymer material comprising polymerizable functional groups.

7. The method for manufacturing a molded ophthalmic article according to claim 3, wherein after the demolding step said mold element is part of the molded ophthalmic article.

8. The method for manufacturing a molded ophthalmic article according to claim 1, wherein in step b, said at least one decorative element is anchored onto a support polymeric thin wafer so as to be fixed inside said cavity.

9. The method for manufacturing a molded ophthalmic article according to claim 8, wherein said support polymeric thin wafer is a transparent carrier film or a functional film having light absorbing or light reflecting characteristics, or combinations thereof.

10. The method for manufacturing a molded ophthalmic article according to claim 1, further comprising before step b a step of surface treatment of said at least one decorative element, wherein said step of surface treatment are selected from one or more of varnish/primer, inks application, chemical etching of the surface, chemical functionalization, plasma etching, corona etching or vacuum physical-chemical surface treatments and/or depositions.

11. The method for manufacturing a molded ophthalmic article according to claim 1, wherein said molded ophthalmic article is subjected to a step of surfacing to reduce its thickness and optionally obtain an optical power.

12. The method for manufacturing a molded ophthalmic article according to claim 1, wherein, said molded ophthalmic article is adapted to have a predefined thickness without a step of surfacing.

13. The method for manufacturing a molded ophthalmic article according to claim 1, wherein said at least one decorative element has added visual functionality selected from photoluminescent, phosphorescent or photochromic effects or combinations thereof.

14. The method for manufacturing a molded ophthalmic article according to claim 1, wherein said at least one decorative element has a maximum thickness of about 80% of a thickness of said ophthalmic article lens where said at least one decorative element is fixed.

15. The method for manufacturing a molded ophthalmic article according to claim 1, wherein said first transparent plastic material, said second transparent plastic material and/or said support polymeric thin wafer have extra functionalities and characteristics selected from photochromic layers, contrast enhancement filters, vacuum coated surfaces, anti-reflective coatings and combination thereof.

16. The method for manufacturing a molded ophthalmic article according to claim 1, wherein, in step b, said at least one decorative element is fixed using an adhesive material.

17. The method for manufacturing a molded ophthalmic article according to claim 1, wherein said at least one decorative element is transparent or present similar or identical refractive indexes compared to the refractive indexes of said transparent plastic materials, wherein said at least one decorative element has no ability to induce a local alteration of the visible light transmission of said molded ophthalmic article wherein said at least one decorative element is placed across the whole surface of said molded ophthalmic article.

18. The method for manufacturing a molded ophthalmic article according to claim 1, wherein said at least one decorative element is visible or said at least one decorative element can induce a local alteration of the visible light transmission of said molded ophthalmic article said at least one decorative element is placed across the surface of said molded ophthalmic article apart from 30 mm circle around the optical center of said molded ophthalmic article.

19. A molded ophthalmic article obtained by a method according to claim 1.

20. The method for manufacturing a molded ophthalmic article according to claim 16, wherein the adhesive material comprises a cyanoacrylate or an acrylic compound.
